(19) United States
(12) Patent Application Publication
(10) Pub. No.: US 2002/0136781 A1
(43) Pub. Date: Sep. 26, 2002

(54) Method for making colloidal cupric compounds and their uses

(76) Inventors: Julio Huato, Jalisco (MX); Tetsuya Ogura, Jalisco (MX)

Correspondence Address: BIRCH STEWART KOLASCH & BIRCH, PO BOX 747, FALLS CHURCH, VA, 22040-0747, US

(21) Appl. No.: 09/811,610

(22) Filed: Mar. 20, 2001

(51) Int. Cl. A01N 59/20

(52) U.S. Cl. 424/630

(57) ABSTRACT

Stable copper colloid solutions are prepared from purified solutions of copper sulfate. The copper sulfate solution is purified by adding oxidizing agent and adding phosphoric acid or phosphate ion to precipitate iron or aluminum. Adjusting the pH yield a colloidal solution. A solid salt is made from the colloidal solution by mixing the colloidal solution with a water miscible organic solvent such as methanol or acetone. The copper colloidal solutions are shown to be effective fungicides against fusarium.

### BACKGROUND OF THE INVENTION

1. Field of the Invention

The invention pertains to novel copper colloidal compounds suitable for use as fungicides and a method for making the colloidal copper compounds.

2. Description of the Related Art

Pathogenic fungi cause a substantial reduction in expected crop yields. Further losses result from fungi during the storage of harvested crops. Although there are over 100,000 known species of fungi, no more than 200 are known to cause serious plant disease.

The classes of fungi associated with important diseases in plant crops include Phycomycetes, Asomycetes, Basidiomycetes and Deuteromycetes. Examples of Phycomycetes include Phytophthora infestans (potato late blight) and Plasmopara viticola (downy mildew of grape). Examples of Ascomycetes include Erysiphe graminis (powdery mildew of wheat/barley), Podosphaera leucotricha (apple powdery mildew) and Pyricularia oryzae (rice blast). Examples of Basidiomycetes include Puccinia spp. (leaf rust of wheat and oats), Rhizoctonia spp. (sheath blight of rice) and Ustiliago spp. (corn smut). Examples of Deuteromycetes include Alternaria spp. (tobacco brown spot), Botrytis spp. (gray mold of grape), Cercospora spp. (leaf spot of sugar beet), Fusarium spp. (wheat blight), Helminthosporium spp. (leaf spot of corn), Pseudocercosporella herpotrichoides (eyespot of wheat), Septoria nodorum (blotch of wheat) and Septoria tritici (wheat leaf blotch).

The fungicides can be classified into systemic and nonsystemic fungicides. The systemic fungicides can penetrate the seed or plant and are then redistributed within to unsprayed parts or subsequent new growth, rendering protection from fungal attack or eradicating a fungus already present. The nonsystemic fungicides have a protectant mode of action and must be applied to the surface of plant generally before infection takes place. The inorganic salts are generally classified as nonsystemic fungicides.

The use of copper as a fungicide is well known. Copper sulfate was used from treating the seed-borne disease wheat bunt (Tilletia spp.) as early as the eighteenth century. In 1882, it was observed that grapevines that had been coated with a mixture of copper sulfate and lime to deter grape pilferage were not infected with grape downy mildew (Plasmopara viticola). This observation resulted in the development of a fungicide called Bordeaux mixture. Copper fungicides currently available for a wide variety of applications include the sulfates (Bordeaux mixture), oxides and oxychlorides and a variety of organic salts such as copper naphthenates and copper quinolinates. Crops protected using copper compounds include vines, fruit, coffee, cocoa and vegetables. Most copper fungicides work by inhibiting fungal spore germination. Sensitive fungi are affected by the uptake of copper salts and its subsequent accumulation, which then complexes with amino, sulfhydryl, hydroxyl or carboxy groups of enzymes resulting in the inactivation of the fungus. Fungicides are discussed in the Kirk-Othmer Encyclopedia of Chemical Technology, 4^{th} Ed. (1994), Volume 12 at pages 204-227.

The most common copper fungicide is Bordeaux mixture (CuSO₄.3Cu(OH)₂.3CaSO₄). The standard formula for Bordeaux mixture is four pounds of copper sulfate, four pounds of hydrated lime and 50 gallons of water. Mix four pounds of the lime in four gallons of water. Do the same for the copper sulfate. Strain the lime mixture through cheesecloth, add to 42 gallons of water, and then add the sulfate mixture. Use immediately. Small amounts can be made by mixing four ounces of hydrated lime in 2 gallons of water. Mix four ounces of copper sulfate in 1 gallon of water. Pour the copper sulfate mixture into the lime mixture. Bordeaux mixture can cause damage to plants if used improperly. Damage or injury results more in humid weather and when the mixture doesn't dry quickly. Bordeaux mixture will leave a bluish-white deposit on the plant.

Once made, Bordeaux mixture is not stable. Poorly stirred Bordeaux mixture is of little value as the active copper compound is not sufficiently finely divided. Other materials are frequently added to Bordeaux mixture in order to increase the stability. If other materials are to be used in the mixture, they may then be added with further agitation. White oil may be used at around 500 mL/100 L of spray or similar amounts of calcium caseinate (500 g/100 L) or molasses (500 mL/100 L). White oil or summer spraying oil may be used at the rate of 500 mL/100 L spray to enhance penetration of the spray under bud scales. Similarly calcium caseinate and molasses have been recommended from time to time for various crops. These are reported to improve the weathering ability of the spray by producing a surface layer on tile leaves which protects the copper particles from being dislodged by rain or irrigation.

Fungicides such as Bordeaux mixture are also characterized by sticking poorly to the plant. The sticking ability of Bordeaux mixture can also be improved by the addition of polymers. However, polymer additives tend to be expensive.

For Burgundy mixture, the slaked lime is replaced by the fully soluble washing soda (sodium carbonate). In other respects, the procedure is the same and the end results are similar although the mixture is said to stick better than Bordeaux but is also more likely to burn sensitive foliage. The main advantage of Burgundy mixture is the ease of use of the washing soda compared with slaked lime. Fresh soda should be used; old material may have less water of crystallization and it is difficult to judge the amount required.

To make an equivalent Burgundy mixture to that described above for Bordeaux, replace the 1 kg of slaked lime with 1.5 kg of washing soda. If the normally crystalline washing soda appears white and powdery, use only 1 kg and then check the made-up mixture for pH before use.

Also related to Bordeaux mixture is Cheshunt mixture which can be used to protect seedlings against damping-off. This fungicide is a mixture of copper sulfate and ammonium carbonate. Make up the mixture a day or so before use. Always dissolve in plastic, never in steel or galvanized buckets. Crush together 50 g of copper sulfate and 275 g of ammonium carbonate (rock ammonia), then store for at least 24 hours in a tightly closed glass jar. Dissolve 50 g of the mixture in 100 to 200 ml of hot water then dilute to 20 L in cold water. Water over seedbeds at 1.0 L/square meter, then wash from leaves. Further treatment may be made as needed, up to twice weekly.

An additional disadvantage associated with the conventional technology arises from any copper ion present above a certain concentration being toxic to all living things including microorganisms and the host plant. Thus, if a cupric solution is applied to kill a phytopathogen, it kills the host plant as well. The conventional copper salts such as cupric hydroxide, cupric basic sulfate, cupric oxychloride, Bordeaux mixture etc. are practically insoluble but show excellent antimicrobial effect to phytopathogens. Two microbicidal paths are proposed:

The dissolved cupric species is cytotoxic to kill microbes.

2) Microbes adhere to the toxic cupric solids present on the plant's surface.

It is required, to realize the second path, that the plant surface must be covered by the copper salt in order for the plant to be protected. If a surface is filled with a fine particles and another with coarse particles forming a monolayer, the thickness of the layer is proportional to the particle size. Therefore, the area covered by a certain size of particles is inversely proportional to the particle size, i.e., fine, colloidal particles can cover wider area than coarser particles using the same weight.

If the microbiocidal effect is attained by the dissolved cupric ion, colloid particles have much faster dissolving velocity than conventional particles, taking into account that the surface area is proportional to the square of particle diameter. In addition, a systemic microbiocidal effect can be expected for a colloidal cupric salt, since the pore size of stomata in leaves is about a couple of μm. On the other hand, colloid particle has a diameter range of 1-0.1 μm, that enables the particle to pass through the pore to the inside of a plant.

A colloidal system is an intimate mixture of two substances, one of which, called the dispersed phase (or colloid), is uniformly distributed in a finely divided state through the second substance, called the dispersion medium (or dispersing medium). The dispersion medium or dispersed phase may be a gas, liquid or solid. A colloid is the phase of a colloidal system made up of particles having dimensions of 10-10,000 angstroms (1-1,000 nm) and which is dispersed in a different phase. See McGraw-Hill Dictionary of Scientific and Technical Terms 5^{th} Ed. at page 408.

Most colloids have all three dimensions within the size range of about 100 nm to 5 μm. If only one dimension (fibrillar geometry) or two dimensions (laminar geometry) exist in this range, unique properties of the high surface area portion of the material may still be observed and even dominate the overall character of a system. The non-Newtonian rheological behavior of fibrillar and laminar clay suspension, the reactivity of catalysts, and the critical magnetic properties of multifilamentary superconductors are examples of the numerous systems that are ultimately controlled by such colloidal materials.

The dispersion factor of a colloid is defined as the ratio of the number of surface atoms to the total number of atoms in the particle. Representative values for 10, 100 and 1,000 nm particles are respectively on the order of 0.15-0.30, 0.40, and 0.003-0.02, depending on the specific dimensions of the atoms or molecules that comprise the particles.

Colloid formation involves either nucleation and growth phenomena or subdivision processes. The former case requires a phase change, while the latter case pertains to the comminution or atomization of coarse particles (solids) or droplets (liquids). There are many possible bulk solution chemical reactions that influence colloidal stability.

Although the conventional art recognizes the applicability of copper compounds as a fungicide, the conventional art also recognizes that the copper fungicides have disadvantages that need to be rectified. Typical of the conventional art copper technology is that of the '253 patent to LeFiles et al. (U.S. Pat. No. 5,298,253) and the '738 patent to LeFiles et al. (U.S. Pat. No. 5,462,738) which pertain to a copper hydroxide dry flowable bactericide/fungicide and a method of making and using same. The bactericide/fungicide of the '253 and '738 patents is made by forming a homogeneous aqueous slurry containing between approximately 5% and 20% by weight (based on the total weight of all dry ingredients) of a first dispersant selected from the group consisting of partially neutralized polyacrylic acid having a pH 5-10 and an average molecular weight of between 1,000 and 10,000 and lignin sulfonate. A second dispersant is used for bentonite clay. A slurry is formed with phosphate stabilized cupric hydroxide and the slurry is spray dried the slurry to thereby form a dry free flowing granular bactericide/fungicide product. The '253 patent and the '738 patent do not indicate that a colloid is present. Although phosphate stabilized cupric hydroxide is mentioned, this solution is obtained from an aqueous slurry using polyacrylic acid as a dispersant.

The '681 patent to Pasek (U.S. Pat. No. 5,492,681) pertains to a method for producing copper oxide. In the method, a copper bearing material, aqueous ammonia, and a sufficient amount of an ammonium salt to double the rate of production of copper oxide in the absence of the salt are placed in a single vessel. The vessel is closed, and oxygen is fed into the vessel. The mixture is stirred and heated to a temperature of between approximately 700° and 130° C. to dissolve the copper bearing material into aqueous ammoniacal copper ion. The aqueous ammoniacal copper ion is reacted with the oxygen in the vessel to form solid copper oxide particles, which are then recovered. The '681 patent is a process based upon ammoniacal copper. The presence of a colloid is not indicated.

The '533 patent to Browne (U.S. Pat. No. 5,310,533) pertains to a method of producing copper compounds involves contacting metallic copper with oxygen or an oxygen-containing gas, with an aqueous solution consisting essentially of water in solution in which is a soluble ammonium salt NH₄X, where X is the anion of the salt, and with ammonia in an amount such that the solution is initially alkaline. As a result of such contact the metallic copper is initially dissolved to form a copper amine Cu(NH₃)₄X and the formation of the amine continues until the saturation concentration of the amine is reached. Subsequently, the amine continuously breaks down to form 3Cu(OH)₂.CuX₂ and the water soluble products of the amine decomposition continuously reform the amine by further reaction with the metallic copper and the oxygen on oxygen-containing gas. The '533 patent is a production of copper compounds using ammoniacal copper. The presence of colloids is not indicated. Neither is the presence of citrate or phosphate indicated.

The '935 patent to Langner et al. (U.S. Pat. No. 4,944,935) pertains to a process of producing blue copper hydroxide, wherein copper metal is treated with an ammonium ion-containing aqueous solution with stirring and with a simultaneous introduction of an oxygen-containing gas and the reaction product is separated from the copper metal. A particulate, floatable copper(II) hydroxide is produced in that a material which contains copper metal is treated at a temperature of 0° to 40° C. with a solution which contains 0.1 to 10 g/l ammonium salt (calculated as NH₄), 0 to 10 g/l ammonium hydroxide (calculated NH₃) and, if desired, 0 to 5 g/l copper(II) salt and the resulting copper(II) hydroxide is separated. The '935 patent pertains to the production of copper hydroxide using ammonium-based compounds. Example 6 discusses ammonium salts selected from chlorides, sulfates, phosphates, nitrate, and acetate. However, a citrate or a colloid is not disclosed.

The '406 patent to Brinkman (U.S. Pat. No. 4,808,406) pertains to a method for producing finely divided stable cupric hydroxide composition of low bulk density comprising contacting solutions of an alkali metal carbonate or bicarbonate and a copper salt, precipitating a basic copper carbonate-basic copper sulfate to a minimum pH in the range of greater than 5 to about 6, contacting the precipitate with an alkali metal hydroxide and converting basic copper sulfate to cupric hydroxide, within the pH range of 7 to 11. The '406 patent pertains to the production of cupric hydroxide from a mixture of basic copper carbonate and basic copper sulfate. Phosphates, citrates, or colloids are not present in the '406 patent technology. The '337 patent to Nakaji et al. (U.S. Pat. No. 4,940,337) provides a stirring apparatus for mixing, with metallic iron masses, a concentrated strongly acidic ferric chloride waste fluid containing iron and one or more other heavy metals in which the content of nickel is highest, the stirring apparatus being characterized by comprising a rotating mechanism for rotating a container, and a passage which is disposed in a rotary shaft and through which excess gas and liquid generated during stirring is discharged into the outside. The '337 patent pertains to the separation of metals from ion chloride waste. The production of a pure copper fungicide is not disclosed.

The '169 patent to Ploss et al. (U.S. Pat. No. 4,404,169) pertains to a process of producing cupric hydroxides having stability in storage if phosphate ions are added to a suspension of copper oxychloride in an aqueous phase. The copper oxychloride is then reacted with alkali metal hydroxide or alkaline earth metal hydroxide, and the cupric hydroxide precipitated as a result of the suspension is washed and then re-suspended and subsequently stabilized by the addition of acid phosphate to adjust a pH value of 7.5 to 9. The suspended copper oxychloride is preferably reacted in the presence of phosphate ions in an amount of 1 to 4 grams per liter of the suspension and at a temperature of 20° to 25° C. and the resulting cupric hydroxide is stabilized with phosphate ions in an amount of 3 to 6 grams per liter of the suspension. The '169 patent reacts copper oxide oxychloride and the presence of phosphate. However, a citrate or colloid is not present in the '169 patent's technology.

The '011 patent to Grubhofer (U.S. Pat. No. 5,773,011) pertains to a synergistic immunological adjuvant which uses N-acetylmuramyl-L-alanyl-D-isoglutamine (MDP) or N-acetylglucosaminyl-N-acetyl-muramyl-L-alanyl-D-isoglutamine (GMDP) in low dose ranges in a combination with zinc-L-proline complex and with immunostimulating lipid in doses which synergistically potentiate the effect of each single component whereby the zinc-L-proline complex contains an excess of L-proline or 5-oxo-L-proline which serves as a solubilizer and dispersing agent for the lipid component. The '011 patent uses copper in the production of an immunological adjuvant. This patent has no direct bearing on the invention besides the presence of copper citrate in the colloid.

The '821 patent and '698 patent, both to Rounds et al. (U.S. Pat. No. 6,149,821; U.S. Pat. No. 6,120,698) pertain to a water purification system with a buffer compound, oxidizer/clarifier compound, and a biocide compound disposed in multiple packets such that the biocide compound and the oxidizer/clarifier compound are contained in different packets. The composition purifies and clarifies water while maintaining the existing water pH. The composition may also include a filtration aid, an algaecide, a calcium-releasing source, a chelator, and a sequestering agent. The algaecide is copper citrate and is present from about 1.5 up to about 2 weight percent. The copper citrate can be formed in-situ by combining copper sulphate and sodium citrate in the composition in about a 1 to 1 molar ratio. However, a colloidal copper citrate is not mentioned in the '821 or '698 patents.

The '707 patent and '162 patent to Saxton (U.S. Pat. No. 5,824,707; U.S. Pat. No. 5,459,162) pertains to a method and composition for improving the weight gain and feed conversion efficiency of swine or poultry which entails feeding an effective amount of copper citrate to the animal. The copper citrate is prepared by reacting either copper or copper hydroxide with citric acid. Copper citrate can also be prepared by reacting sodium citrate (trisodium citrate) with copper sulfate. The resulting reaction produces copper citrate in an aqueous medium. The copper citrate, which is a solid, will precipitate from the aqueous phase and can be separated by simple filtration and drying. However, colloidal copper citrate is not mentioned in the '707 patent or '162 patent.

The '904 patent to Samad et al. (U.S. Pat. No. 5,632,904) pertains to metal-ligand complexes produced by coordination chemistry for use as a biocide and a method for detoxifying water or effluent are disclosed. Metallic biocides are bound with acceptable complexing agents as a type of coordination compound to shield the metal ions from other reactants in the water supply being treated while keeping the metal ions available for biocidal action. In particular, pre-mixed solutions of metal-ligand complexes are added as a disinfectant to water containing ions such as calcium, iron, carbonates, chlorides, nitrates, phosphates, and sulfates. Example 1 discusses a biocidal solution composed of citric acid (the ligand, or complexing agent) and copper. However, colloidal copper citrate is not mentioned in the '904 patent.

The '091 patent to Fortunati et al. (U.S. Pat. No. 5,369,091) pertains to a process for producing YBCO powders by pyrolysis that involves preparing a clear aqueous solution containing the ions yttrium, barium and copper, in the final proportions desired for the powder, in the form of complex compounds, preferably citric complex compounds, and in the presence of a detonating system such as a combination of ammonium ions and nitrate ions. The clear solution is then concentrated by evaporation, until a violent combustion is triggered which is carried out at a high temperature, higher than 250° C. and preferably higher than 850° C. Citric acid is used as a combustion moderator. However, colloidal copper citrate is not mentioned in the '091 patent.

As has been shown, there are significant disadvantages associated with copper based fungicides and agricultural chemicals. These disadvantages include the poor stability of copper fungicides such as Bordeaux mixture. The activity of these fungicides is hampered by the active copper compound not being sufficiently finely divided. Additional disadvantages arise from the poor sticking ability of the copper fungicides, which result in large dosages of the fungicide being required. These disadvantages can be alleviated by the development of highly stable and stickable copper compounds.

### SUMMARY OF THE INVENTION

The invention, in part, pertains to a stable colloidal cupric solution.

The invention, in part, pertains to a colloidal cupric solution substantially free from aluminum, ferric and ferrous ions.

The invention, in part, pertains to a colloidal basic cupric salt obtained from an aqueous solution in which a water-soluble organic solvent has been mixed.

The invention, in part, pertains to a colloidal cupric compound obtained by reacting organic acids such as citric acid or amino acids with a cupric solution substantially free from aluminum, ferrous and ferric ions.

The invention, in part, pertains to method for treating plant fungi using a colloidal cupric salt.

It is to be understood that both the foregoing general description and the following detailed description are exemplary and explanatory and are intended to provide further explanation of the invention as claimed.

### DETAILED DESCRIPTION

Advantages of the present invention will become more apparent from the detailed description given herein after. However, it should be understood that the detailed description and specific examples, while indicating preferred embodiments of the invention, are given by way of illustration only, since various changes and modifications within the spirit and scope of the invention will become apparent to those skilled in the art from this detailed description.

Copper can take on the cuprous Cu⁺and cupric Cu²⁺ oxidation states. The cupric compounds of the invention are represented by formula I:

CuAxBy (I)

where A and B are anions,

0≦x≦2, and

0≦y≦2.

The relationship between x and y is further clarified by Equation II:

mx+ny=2 (II)

where m and n are coefficients equal to oxidation numbers of the anions A and B, respectively.

The anion A can be Cl⁻, Br⁻, I⁻, F⁻, NO₃⁻ SO₄²⁻, PO₄³⁻or RCOO⁻ where R is H or a C₁-C₂₀ straight chain or branched hydrocarbon such as methyl, ethyl, propyl, isopropyl butyl, isobutyl, tert-butyl, pentyl, isopentyl, etc. R can also an aromatic group such as benzyl, tolyl, naphthyl, etc. The anion A can also be an anion of an organic acid such as tartrate²⁻, citrate³⁻ or an amino acid residue such as metyonine.

The cupric compound of formula I is produced as either a stable colloid solution or a colloidal solid compound. A starting cupric solution is purified to remove impurities such a ferrous, ferric, aluminum ions, etc. which can be the basis of a destabilizing factor flocculating the colloidal particles. The ferrous, ferric or aluminum ions are removed by adding phosphoric acid or phosphate ion. If ferrous ion or other reduced species are present, they are oxidized by using an oxidizing agent such as hydrogen peroxide, hypocholorite ion, bleach, ozone injection, etc.

In the process of making cupric compounds such as cupric citrate from Cu(OH)₂, metal ions, especially Fe(II) ion catalyzes the following reaction:

Cu(OH)₂→CuO+H₂O

The inventors found that the true catalytic species is Fe²⁺ occluded (interstitially) in the crystal lattice of Cu(OH)₂, which changes its molecular structure on being oxidized to Fe³⁺ and destroys the Cu(OH)₂ crystal to form more stable product, CuO. In turn, the CuO formed catalyzes the same dehydration reaction. Therefore, inhibition of this reaction is necessary to obtain a stable product.

The process of making colloidal compounds such as cupric citrate from Cu(OH)₂ uses metal ions, especially Fe(III) and Al(III) ions, to flocculate the desired colloidal particles.

Following purification, the aqueous cupric solution is adjusted to a pH of about 5 by a base. Preferably, the base is a weak base such as ammonia, sodium carbonate, sodium bicarbonate, lime, etc.

The cupric colloid solution depends on the counter ion of the starting cupric solution. Examples of the cupric colloid solution include solutions of basic cupric sulfate or cupric oxychloride.

A colloid solution is produced by reacting citric acid, tartaric acid, amino acids, etc. to the purified cupric solution free of iron and aluminum, and a colloid solution of the corresponding salt is produced. Solid colloids are produced by adding a water miscible organic solvent to the corresponding colloid solution. The water miscible organic solvent can be methanol, ethanol, propanol, isopropanol, butanol, isobutanol, tert-butanol, acetone, tetrahydrofuran, ethylene glycol, propylene glycol, polyglycols, glycol ethers, etc.

The solid colloid salts can also be prepared by reacting an organic solution of copper salt such as cupric chloride (CuCl₂) in methanol with citric acid, tartaric acid, amino acids, etc. in water or an organic solvent.

### EXAMPLE 1

### Removal of Fe²⁺, Fe³⁺ and Al³⁺ From a CuSO₄ Solution After Oxidizing by H₂O₂

10 ml of 50% H₂O₂ and 10 ml of 70% H₃PO₄ were added dropwise to 1L of 1M copper sulfate solution that had been prepared from crystalline CuSO₄.5H₂O. The pH of the solution was adjusted to 3 using 3 M aqueous Na₂CO₃ solution, and the solution was then heated to 100° C. on a hot plate fitted with a magnetic stirrer. When the solution reached 100° C., the pH was readjusted to 3 and left overnight at 100° C. The solid precipitate was then removed by filtration.

### EXAMPLE 2

### Removal of Fe²⁺, Fe³⁺ and Al³⁺ From a CuSO₄ Solution After Oxidizing by Bleach.

10 ml of bleach containing 6% active chlorine and 10 ml of 70% H₃PO₄ were added dropwise to 1 L of 1M copper sulfate solution that had been prepared from crystalline CuSO₄.5H₂O. The pH of the solution was adjusted to 3 using 15 N aqueous NH₃ solution, and the solution was then heated to 100° C. on a hot plate fitted with a magnetic stirrer. When the solution reached 100° C., the pH was readjusted to 3 and left overnight at 100° C. The solid precipitate was then removed by filtration.

### EXAMPLE 3

### Removal of Fe ²⁺, Fe³⁺ and Al³⁺ From Mother Liquor After Oxidizing by H₂O₂

10 ml of 50% H₂O₂ and 10 ml of 70% H₃PO₄ were added dropwise to 1L of mother liquor left after the crystallization of copper sulfate containing 1 M Cu²⁺ ion, 200 ppm Fe and 200 ppm Al. The pH of the solution was adjusted to 3 using 15 N aqueous NH₃ solution, and the solution was then heated to 100° C. on a hot plate fitted with a magnetic stirrer. When the solution reached 100° C., the pH was readjusted to 3 and left overnight at 100° C. The solid precipitate was then removed by filtration.

### EXAMPLE 4

### Removal of Fe²⁺, Fe³⁺ and Al³⁺ From Mother Liquor After Oxidizing by Bleach.

10 ml of bleach containing 6% active chlorine and 10 ml of 70% H₃PO₄ were added dropwise to 1 L of mother liquor left after the crystallization of copper sulfate. The mother liquor originally contained 1 M Cu²⁺ ion, 200 ppm Fe and 200 ppm Al. The pH of the solution was adjusted to 3 using 3M Na₂CO₃ solution, and the solution was then heated to 100° C. on a hot plate fitted with a magnetic stirrer. When the solution reached 100° C., the pH was readjusted to 3 and left overnight at 100° C. The solid precipitate was then removed by filtration.

### EXAMPLE 5

### Removal of Fe²⁺, Fe²⁺ and Al³⁺ From a CuCl₂ Solution After Oxidizing by Bleach.

10 ml of bleach containing 6% active chlorine and 10 ml of 70% H₃PO₄ were added dropwise to 1 L of 1M copper chloride solution that had been prepared from reagent grade CuSO₄.5H₂O. The pH of the solution was adjusted to 3 using 15 N aqueous NH₃ solution, and the solution was then heated to 100° C. on a hot plate fitted with a magnetic stirrer. When the solution reached 100° C., the pH was readjusted to 3 and left overnight at 100° C. The solid precipitate was then removed by filtration.

### EXAMPLE 6

### Colloidal Cu(OH)₂

The solution obtained in Example 1 was adjusted to contain 0.1M copper ion solution. To this solution was added 0.3 M Na₂CO₃ dropwise with vigorous stirring until a pH of 8 was attained. A clear blue solution of colloidal Cu(OH)₂ was obtained. No precipitate was observed in this solution after standing at room temperature for 24 h.

20 ml of the colloidal Cu(OH)₂ solution was added to 200 ml of methanol with vigorous stirring. The precipitate formed was collected by filtering through a sintered glass filter and was dried by a nitrogen flow. Scanning electron microscopy showed the precipitate was non-crystalline particles with diameters no more than 1 μm.

A colloid solution was obtained by adding the precipitate to pure water.

### EXAMPLE 7

### Cu(C₅H₁₀NO₂S)₂

The solution obtained in Example 3 was adjusted to contain 1M copper ion solution. To 100 ml of this solution was added 29.9 gr of methionine (HMet) (0.2 mole of amino acid). The pH was adjusted to 6 by adding 3 M Na₂CO₃ dropwise with vigorous stirring. A clear blue solution of colloidal Cu(Met)₂ was obtained. No precipitate was observed in this solution after standing at room temperature for 24 hours.

20 ml of the colloidal Cu(Met)₂ solution was added to 200 ml of reagent grade methanol with vigorous stirring. The precipitate formed was collected by filtering through a sintered glass filter and was dried by a nitrogen flow. Scanning electron microscopy showed the precipitate was non-crystalline particles with diameters no more than 1 μm.

A colloid solution was obtained by adding the precipitate to pure water.

### EXAMPLE 8

### Cu₂(OH)citrate

The solution obtained from Example 4 was adjusted to contain 1M copper ion. To 100 ml of this solution was added 10.5 g (0.05 mole) of crystalline citric acid monohydrate. The pH was adjusted to 5 by adding 3 M Na₂CO₃ solution with vigorous stirring. A clear blue solution of colloidal Cu₂(OH)citrate was obtained.

20 ml of the colloidal Cu₂(OH)citrate solution was added to 200 ml of reagent grade acetone with vigorous stirring. The precipitate formed was collected by filtering through a sintered glass filter and was dried by a nitrogen flow. Scanning electron microscopy showed the precipitate was non-crystalline particles with diameters no more than 1 μm.

A colloid solution was obtained by adding the precipitate to pure water.

### EXAMPLE 9

### Cu from Cu₂(OH)citrate

0.3 ml of 0.02 M colloidal copper citrate solution was sprayed on a 6 cm diameter silicon wafer at a temperature of 50° C. under good ventilation. The wafer was dried and then heated at 300° C. under a vacuum for 1 hour. The copper citrate on the wafer turned into a thin metallic copper film. The copper film was so active that it was occasionally observed to ignite when air was introduced while the wafer was hot.

### EXAMPLE 10

### Colloidal Copper Citrate Against Fusarium spp on Tomato Seedlings

Four seeding trays having 500 divisions containing agricultural peat moss were seeded with tomato seeds (variety: Catalina Criollo). Each division was kept at 25±3° C. with irrigation every morning. All tomato plats grew well to 18±2 cm after 45 days. The trays with the tomato plants were treated in the following manner:

Tray 1. Blank. The plants were irrigated every morning for 24 days.

Tray 2. Fusarium spp. On the 48^{th} day, the plants in this tray were sprayed by 50×10⁶ spores of fusarium strain suspended in 100 ml of water. The pathogen was isolated from a tomato plant diseased by a stem rot.

Tray 3. Copper citrate colloid. 100 ml of copper citrate colloid solution (50 mg Cu/L) was sprayed on the 45^{th} day and continued spraying one every week for 25 days.

Tray 4. Fusarium and copper citrate colloid. 100 ml of copper citrate colloid solution was sprayed on the 45^{th} day and continued spraying one ever week for 325 days. On the 48^{th} day the plants in this tray were sprayed by 50×10⁶ spores of fusarium strain as used in Tray 2.

The plants in Tray 2 died (50%) on the 65^{th} day and practically all the plants were dead on the 69^{th} day from fusarium. The plants in Trays 3 and 4 resisted fusarium attack and only 5% showed fusarium disease on the leaves. No toxicity due to the copper citrate was noted.

It is to be understood that the foregoing descriptions and specific embodiments shown herein are merely illustrative of the best mode of the invention and the principles thereof, and that modifications and additions may be easily made by those skilled in the art without departing for the spirit and scope of the invention, which is therefore understood to be limited only by the scope of the appended claims.

We claim:

1. A colloidal cupric compound of the formula (I):
CuAxBy (I)
where A and B are anions,
0≦x≦2, and
0≦y≦2.
The relationship between x and y is further clarified by Equation II:
mx+ny−2 (II)
where m and n are coefficients equal to oxidation numbers of the anion A and B, respectively,
the anion A representing Cl⁻, Br⁻, I⁻, F⁻, NO₃⁻ SO₄²⁻, PO₄³⁻, RCOO⁻ where R is H, a C₁-C₂₀ straight chain or branched hydrocarbon, or an aromatic group, tartrate²⁻, citrate³⁻ or an amino acid residue;
the colloidal cupric compound made by a process comprising:
purifying a Cu²⁺ solution; and
raising the pH of the solution.

2. The colloidal cupric compound of claim 1, wherein the Cu²⁺ solution is prepared from CuSO₄.5H₂O.

3. The colloidal cupric compound of claim 1, wherein purifying the Cu²⁺ solution is performed by:
adding an oxidizing agent and H₃PO₄ to the solution;
adjusting the pH to 3;
heating the solution; and
removing the solids.

4. The colloidal cupric compound of claim 3, wherein the oxidizing agent is H₂O₂ or bleach.

5. The colloidal cupric compound of claim 3, wherein adjusting the pH to 3 is performed by adding Na₂CO₃ solution.

6. The colloidal cupric compound of claim 1, wherein the process further comprises:
adding the solution to an organic solvent to form a precipitate; and
collecting the precipitate.

7. The colloidal cupric compound of claim 6, wherein the organic solvent is methanol or acetone.

8. The colloidal cupric compound of claim 6, wherein the precipitate is dried by nitrogen flow.

9. A process for producing a colloidal cupric compound of the formula (I):
CuAxBy (I)
where A and B are anions,
0≦x≦2, and
0≦y≦2.
The relationship between x and y is further clarified by Equation II:
mx+ny=2 (II)
where m and n are coefficients equal to oxidation numbers of the anion A and B, respectively,
the anion A representing Cl⁻, Br⁻, I⁻, F⁻, NO₃⁻ SO₄²⁻, PO₄³⁻, RCOO⁻ where R is H, a C₁-C₂₀ straight chain or branched hydrocarbon, or an aromatic group, tartrate²⁻, citrate³⁻ or an amino acid residue;
the process comprising:
purifying a Cu²⁺ solution; and
raising the pH of the solution.

10. The process claim 9, wherein the Cu²⁺ solution is prepared from CuSO₄.5H₂O.

11. The process of claim 9, wherein purifying the Cu²⁺ solution is performed by:
adding an oxidizing agent and H₃PO₄ to the solution;
adjusting the pH to 3;
heating the solution; and
removing the solids.

12. The process of claim 11, wherein the oxidizing agent is H₂O₂ or bleach.

13. The process of claim 11, wherein adjusting the pH to 3 is performed by adding Na₂CO₃ solution.

14. The process claim 9, wherein the process further comprises:
adding the solution to an organic solvent to form a precipitate; and
collecting the precipitate.

15. The process of claim 14, wherein the organic solvent is methanol or acetone.

16. The process of claim 14, further comprising drying the precipitate by nitrogen flow.

17. A method of controlling fungal diseases in plants comprising the step of applying to said plants a fungicide comprising the colloidal cupric compound of claim 1.

18. A method of controlling fungal diseases in plants comprising the step of applying to said plants a fungicide made according to the process of claim 9.

19. The method of claim 17, wherein the fungicide is colloidal copper citrate.

20. The method of claim 18, wherein the fungicide is colloidal copper citrate.

21. The method of claim 17, wherein the fungicide is colloidal copper citrate solution containing about 50 mg/L copper.

22. The method of claim 18, wherein the fungicide is colloidal copper citrate solution containing about 50 mg/L copper.
